(19) United States
(12) Patent Application Publication
(10) Pub. No.: US 2025/0154349 A1
(43) Pub. Date: May 15, 2025

(54) FLAME RETARDANT PROPYLENE COMPOSITION

(71) Applicant: SABIC GLOBAL TECHNOLOGIES B.V., Bergen op Zoom (NL)

(72) Inventors: Junhua ZHANG, Etten-Leur (NL); Jose SALES FERNANDEZ, Maastricht (NL); Gerard Jan, Eduard BIEMOND, Brunssum (NL); Theodosia KOURKOUTSAKI, Aachen (DE); Johannes Gerardus, Petrus GOOSSENS, Heeswijk-Dinther (NL)

(21) Appl. No.: 18/722,326

(22) PCT Filed: Dec. 16, 2022
(86) PCT No.: PCT/EP2022/086271

§ 371 Date: Jun. 20, 2024

(30) Foreign Application Priority Data
Dec. 21, 2021 (EP) 21216495.8

(51) Int. Cl. C08L 23/12; C08J 3/20; C08K 3/32; C08K 5/136; C08K 5/3492

(52) U.S. Cl. CPC C08L 23/12; C08J 3/201; C08K 3/32; C08K 5/136; C08K 5/34928; C08J 2323/12; C08J 2423/16; C08J 2427/18; C08K 2003/323; C08K 2201/014; C08L 2201/02; C08L 2203/30; C08L 2205/025; C08L 2205/03; C08L 2207/02

(57) ABSTRACT

A composition includes (A) a propylene-based polymer, (B) a flame retardant composition and (C) an anti-drip agent in the form of particles comprising a fluoropolymer and having an average particle size as determined in accordance with ISO13320:2020 of 0.1 to 50 μm.

### CROSS REFERENCE TO RELATED APPLICATIONS

This application is a National Stage application of PCT/EP2022/086271, filed Dec. 16, 2022, which claims the benefit of European Application No. 21216495.8, filed Dec. 21, 2021, both of which are incorporated by reference in their entirety herein.

### BACKGROUND

The invention relates to a flame retardant composition comprising a propylene-based polymer, to a process for obtaining such composition, and an article comprising such composition.

In order to improve the flame retardancy performance of polypropylene (PP), a flame retardant (FR) is often added to the PP.

WO2018019762 discloses a flame retardant polypropylene composition comprising (A) a polypropylene-based polymer, (B) a first flame retardant in the form of particles comprising ammonium polyphosphate and at least one phosphate and (C) a second flame retardant comprising an aromatic phosphate ester. WO2018019762 mentions that the composition has a good flame retardancy and a high melt flow rate which allows good processability. The compositions in the examples comprise an anti-drip agent which is Teflon (PTFE) encapsulated by Styrene-Acrylonitrile copolymer.

There is a demand in the art for a propylene composition with an improved flame retardancy.

### SUMMARY

It is an objective of the present invention to provide a flame retardant propylene composition in which the above-described and/or other needs are met.

Accordingly, the present invention provides a composition comprising (A) a propylene-based polymer, (B) a flame retardant composition and (C) an anti-drip agent in the form of particles comprising a fluoropolymer and having an average particle size as determined in accordance with ISO13320:2020 of 0.1 to 50 μm.

### DETAILED DESCRIPTION

### (A) Polypropylene-Based Polymer

Preferably, the amount of the component (A) is 55 to 95 wt %, for example 60 to 90 wt % or 65 to 85 wt %, with respect to the total composition.

### Homopolymer and Non-Heterophasic Copolymer

The polypropylene-based polymer may comprise or may be a propylene homopolymer or a propylene copolymer including random copolymers and (multi) block copolymers.

The copolymer is preferably a random copolymer. The copolymer may consist of at least 70 wt % of propylene monomer units and up to 30 wt % of ethylene and/or α-olefin monomer units, based on the total weight of the copolymer. Preferably, the α-olefin is selected from the group of α-olefins having 4-10 carbon atoms, for example 1-butene, 1-pentene, 4-methyl-1-pentene, 1-hexene, 1-heptene or 1-octene. The propylene copolymer is preferably a propylene-ethylene copolymer.

The amount of ethylene and/or α-olefin monomer units in the propylene copolymer is preferably 1-15 wt %, more preferably 1-10 wt %, more preferably 1-6 wt %, more preferably 1-4 wt % based on the total weight of the propylene copolymer. When the polypropylene-based polymer comprises a propylene α-olefin copolymer, the propylene copolymer is preferably a propylene-ethylene random copolymer wherein the amount of ethylene monomer units is 1-15 wt %, more preferably 1-10 wt %, more preferably 1-6 wt %, more preferably 1-4 wt % based on the total weight of the propylene copolymer.

The MFI of some preferred propylene homopolymer or propylene copolymer may be for example at least 0.1 dg/min, at least 1.0 dg/min, at least 5 dg/min, at least 10 dg/min, at least 20 dg/min, at least 30 dg/min or at least 40 dg/min and/or at most 100 dg/min, at most 80 dg/min, at most 60 dg/min or at most 50 dg/min, measured according to ISO1133-1:2011 (2.16 kg/230° C.).

In some preferred embodiments, the propylene-based polymer is or comprises a mixture a propylene homopolymer and a propylene copolymer such as a propylene-ethylene copolymer.

### Heterophasic Propylene Copolymer

The polypropylene-based polymer may comprise or may be a heterophasic propylene copolymer consisting of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %.

Heterophasic propylene copolymers, also known as impact propylene copolymers or propylene block copolymers, are an important class of polymers due to their attractive combination of mechanical properties, such as impact strength over a wide temperature range and their low cost. These copolymers find a wide range of applications ranging from the consumer industry (for example packaging and housewares), the automotive industry to electrical applications.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer.

These steps are preferably performed in different reactors. The catalyst systems for the first step and for the second step may be different or same.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-a-olefin copolymer may be determined by ¹³C-NMR, as well known in the art.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

The melt flow index (MFI) of the propylene-based matrix (before the heterophasic propylene copolymer is mixed into the composition of the invention), MFIPP, may be for example at least 0.1 dg/min, at least 0.2 dg/min, at least 0.3 dg/min, at least 0.5 dg/min, and/or for example at most 20 dg/min, at most 10 dg/min, at most 5.0 dg/min, at most 3.0 dg/min, at most 1.0 dg/min, measured according to ISO1133-1:2011 (2.16 kg/230° C.).

Preferably, the propylene-based matrix is present in an amount of 60 to 98 wt %, for example at most 97 wt %, at most 96 wt %, at most 95 wt %, at most 93 wt % or at most 91 wt %, based on the total heterophasic propylene copolymer. Preferably, the propylene-based matrix is present in an amount of at least 70 wt %, more preferably at least 75 wt %, for example at least 80 wt %, at least 85 wt %, at least 87 wt % or at least 90 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 5 to 65 wt %, for example at least 10 wt %, at least 20 wt %, at least 30 wt %, at least 40 wt % or at least 45 wt % and/or at most 60 wt %, at most 58 wt %, at most 55 wt % or at most 50 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFIrubber, may be for example at least 0.001 dg/min, at least 0.03 dg/min or at least 0.05 dg/min, and/or for example at most 0.1 dg/min or 0.01 dg/min. MFIrubber is calculated according to the following formula:

$$MFIrubber = 10 \hat{} ( \frac{Log MFIheterophasic - matrix content * Log MFImatrix}{rubber content} )$$

wherein MFIheterophasic is the MFI (dg/min) of the heterophasic propylene copolymer measured according to ISO1133-1:2011 (2.16 kg/230° C.), MFImatrix is the MFI (dg/min) of the propylene-based matrix measured according to ISO1133-1:2011 (2.16 kg/230° C.), matrix content is the fraction of the propylene-based matrix in the heterophasic propylene copolymer, rubber content is the fraction of the dispersed ethylene-α-olefin copolymer in the heterophasic propylene copolymer. The sum of the matrix content and the rubber content is 1. For the avoidance of any doubt, Log in the formula means log₁₀.

Preferably, the dispersed ethylene-α-olefin copolymer is present in an amount of 2.0 to 40 wt %, for example at least 3.0 wt %, at least 4.0 wt %, at least 5.0 wt %, at least 7.0 wt % or at least 9.0 wt %, based on the total heterophasic propylene copolymer. Preferably, the dispersed ethylene-α-olefin copolymer is present in an amount of at most 30 wt %, more preferably at most 25 wt %, for example at most 20 wt %, at most 15 wt %, at most 13 wt % or at most 10 wt %, based on the total heterophasic propylene copolymer.

In the heterophasic propylene copolymer in the composition of the invention, the sum of the total weight of the propylene-based matrix and the total weight of the dispersed ethylene-α-olefin copolymer is 100 wt % of the heterophasic propylene copolymer.

Preferably, the heterophasic propylene copolymer has a fraction soluble in p-xylene at 25° C. (CXS) measured according to ISO 16152:2005 of 2.0 to 40 wt %, for example 9.0 to 25 wt %.

Preferably, the amount of ethylene monomer units in the heterophasic propylene copolymer (sometimes referred as TC2) is in the range of 0.5 to 5.0 wt %, for example 1.0 to 3.0 wt %, based on the heterophasic propylene copolymer.

Preferably, in the heterophasic propylene copolymer according to the invention, the comonomer in the propylene-α-olefin copolymer is selected from ethylene and the group of α-olefins having 4 to 10 carbon atoms and the α-olefin in the ethylene-α-olefin copolymer is selected from the group of α-olefins having 3 to 8 carbon atoms. Most preferably, in the heterophasic propylene copolymer according to the invention, the comonomer in the propylene-α-olefin copolymer is ethylene and the α-olefin in the ethylene-α-olefin copolymer is propylene.

The values of the MFI of the propylene-based matrix (MFImatrix) and the MFI of the dispersed ethylene-α-olefin elastomer (MFIrubber) mentioned herein are understood as the values before the heterophasic propylene copolymer is mixed with other components to obtain the composition according to the invention.

The value of the MFI of the heterophasic propylene copolymer (MFIheterophasic) refers to the final MFI of the heterophasic propylene copolymer. To exemplify this: In case the heterophasic propylene copolymer is not subjected to vis-breaking or shifting by melt-mixing with a peroxide, the MFIheterophasic is the original MFI value of the heterophasic propylene copolymer. In case the heterophasic propylene copolymer is subjected to vis-breaking or shifting by melt-mixing with a peroxide, the MFIheterophasic is the value of the heterophasic propylene copolymer after such vis-breaking or shifting.

In some preferred embodiments, the composition according to the invention comprises one type of heterophasic propylene copolymer.

In other preferred embodiments, the propylene-based polymer is or comprises a mixture of heterophasic propylene copolymers having different MFI.

The heterophasic propylene copolymer in the composition according to the invention may have a melt flow index as measured according to ISO1133-1:2011 (2.16 kg/230° C.) of 0.1 to 100 dg/min.

The MFI of some preferred heterophasic propylene copolymers may be for example at least 5 dg/min, at least 10 dg/min or at least 15 dg/min and/or at most 50 dg/min, at most 40 dg/min, at most 30 dg/min or at most 25 dg/min, measured according to ISO1133-1:2011 (2.16 kg/230° C.). Preferably, the amount of the dispersed ethylene-α-olefin copolymer is 10 to 50 wt %, preferably 30 to 40 wt %, based on the heterophasic propylene copolymer and preferably the amount of ethylene in the ethylene-α-olefin copolymer is 40 to 60 wt % based on the ethylene-α-olefin copolymer. In some preferred embodiments, the propylene-based polymer consists of such heterophasic propylene copolymer.

The MFI of some preferred heterophasic propylene copolymers may be for example at least 0.1 dg/min, at least 0.2 dg/min, at least 0.3 dg/min, at least 0.5 dg/min, at least 1.0 dg/min, at least 1.5 dg/min or at least 2.0 and/or for example at most 10 dg/min, at most 8 dg/min or at most 5 dg/min, measured according to ISO1133-1:2011 (2.16 kg/230° C.). Preferably, the amount of the dispersed ethylene-α-olefin copolymer is 10 to 50 wt %, preferably 21 to 30 wt %, based on the heterophasic propylene copolymer and preferably the amount of ethylene in the ethylene-α-olefin copolymer is 40 to 60 wt % based on the ethylene-α-olefin copolymer.

The MFI of some preferred heterophasic propylene copolymers may be for example at least 5 dg/min or at least 10 dg/min and/or at most 40 dg/min, at most 30 dg/min, at most 25 dg/min or at most 20 dg/min, measured according to ISO1133-1:2011 (2.16 kg/230° C.). Preferably, the amount of the dispersed ethylene-α-olefin copolymer is 10 to 50 wt %, preferably 10 to 20 wt %, based on the heterophasic propylene copolymer and preferably the amount of ethylene in the ethylene-α-olefin copolymer is 40 to 60 wt % based on the ethylene-α-olefin copolymer.

The MFI of some preferred heterophasic propylene copolymers may be for example at least 20 dg/min, at least 25 dg/min, at least 30 dg/min or at least 35 dg/min and/or for example at most 100 dg/min, at most 80 dg/min, at most 60 dg/min or at most 50 dg/min, measured according to ISO1133-1:2011 (2.16 kg/230° C.). Preferably, the amount of the dispersed ethylene-α-olefin copolymer is 10 to 50 wt %, preferably 15 to 25 wt %, based on the heterophasic propylene copolymer and preferably the amount of ethylene in the ethylene-α-olefin copolymer is 50 to 70 wt % based on the ethylene-α-olefin copolymer.

In some preferred embodiments, the propylene-based polymer is a mixture of heterophasic propylene copolymers, wherein the mixture comprises
a heterophasic propylene copolymer having an MFI measured according to ISO1133-1:2011 (2.16 kg/230° C.) of at least 0.1 dg/min, at least 0.2 dg/min, at least 0.3 dg/min, at least 0.5 dg/min, at least 1.0 dg/min, at least 1.5 dg/min or at least 2.0 and/or for example at most 10 dg/min, at most 8 dg/min or at most 5 dg/min, wherein the amount of the dispersed ethylene-α-olefin copolymer is 10 to 50 wt %, preferably 21 to 30 wt %, based on the heterophasic propylene copolymer and preferably the amount of ethylene in the ethylene-α-olefin copolymer is 40 to 60 wt % based on the ethylene-α-olefin copolymer and
a heterophasic propylene copolymer having an MFI measured according to ISO1133-1:2011 (2.16 kg/230° C.) of at least 5 dg/min or at least 10 dg/min and/or at most 40 dg/min, at most 30 dg/min, at most 25 dg/min or at most 20 dg/min, wherein the amount of the dispersed ethylene-α-olefin copolymer is 10 to 50 wt %, preferably 10 to 20 wt %, based on the heterophasic propylene copolymer and preferably the amount of ethylene in the ethylene-α-olefin copolymer is 40 to 60 wt % based on the ethylene-α-olefin copolymer. The mixture may further comprise
a heterophasic propylene copolymer having an MFI measured according to ISO1133-1:2011 (2.16 kg/230° C.) of at least 20 dg/min, at least 25 dg/min, at least 30 dg/min or at least 35 dg/min and/or for example at most 100 dg/min, at most 80 dg/min, at most 60 dg/min or at most 50 dg/min, wherein the amount of the dispersed ethylene-α-olefin copolymer is 10 to 50 wt %, preferably 15 to 25 wt %, based on the heterophasic propylene copolymer and preferably the amount of ethylene in the ethylene-α-olefin copolymer is 50 to 70 wt % based on the ethylene-α-olefin copolymer.

### (B) Flame Retardant Composition

The flame retardant composition may be a halogen-free flame retardant composition or a halogenated flame retardant composition.

Preferably, the amount of the component (B) with respect to the total composition is 1.0 to 40 wt %, preferably 3.0 to 30 wt %, more preferably 5.0 to 25 wt %, more preferably 10 to 20 wt %.

### Halogen-Free Flame Retardant Composition

The halogen-free flame retardant composition may comprise an organophosphorus compound.

Preferably, the organophosphorus compound is selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate) and combinations thereof.

More preferably, the organophosphorus compound is selected from the group consisting of melamine phosphate, melamine polyphosphate, melamine pyrophosphate, piperazine phosphate, piperazine polyphosphate, piperazine pyrophosphate and 2-methylpiperazine monophosphate and combinations thereof.

In some embodiments, the organophosphorus compound comprises a first compound selected from melamine phosphate, melamine polyphosphate and melamine pyrophosphate a second compound selected from piperazine phosphate, piperazine polyphosphate, piperazine pyrophosphate and 2-methylpiperazine monophosphate.

The weight ratio between the first compound and the second compound may e.g. be 1:5 to 5:1, for example 1:5 to 1:1 or 1:1 to 5:1.

The halogen-free flame retardant composition may further comprise zinc oxide and/or ammonium polyphosphate.

Preferably, the amount of zinc oxide in the halogen-free flame retardant composition with respect to the total amount of the organophosphorus compound, zinc oxide and ammonium polyphosphate is 1.0 to 10 wt %.

The halogen-free flame retardant composition may further comprise ammonium polyphosphate.

Preferably, the amount of ammonium polyphosphate in the halogen-free flame retardant composition with respect to the total amount of the organophosphorus compound, zinc oxide and ammonium polyphosphate is 5.0 to 15 wt %.

In some embodiments, the halogen-free flame retardant composition comprises particles comprising
a first compound selected from melamine phosphate, melamine polyphosphate and melamine pyrophosphate,
a second compound selected from piperazine phosphate, piperazine polyphosphate, piperazine pyrophosphate and 2-methylpiperazine monophosphate,
zinc oxide and
ammonium polyphosphate,
wherein
the amount of the first compound, for example melamine phosphate, is 50 to 80 wt %,
the amount of the second compound, for example piperazine phosphate, is 10 to 25 wt % and
the amount of zinc oxide is 1.0 to 10 wt %,
the amount of the ammonium polyphosphate is 5.0 to 15 wt %,
with respect to the particles.

Preferably, the amount of the particles with respect to the total composition is 15 to 40 wt %.

In some embodiments, the halogen-free flame retardant composition further comprises an aromatic phosphate ester. Preferably, the amount of the aromatic phosphate ester flame retardant is 0.1 to 15 wt % with respect to the total composition.

Preferably, the aromatic phosphate ester is selected from the group consisting of resorcinol bis(diphenyl phosphate); tetraphenyl resorcinol bis(diphenylphosphate); bisphenol A bis(diphenyl phosphate); bisphenol A diphosphate; resorcinol bis(di-2,6-xylyl phosphate), phosphoric acid, mixed esters with [1,1 ‘-biphenyl]-4-4’-diol and phenol; phosphorictrichloride, polymer with 1,3-benzenediol,phenylester; 1,3-phenylene-tetrakis(2,6-dimethylphenyl)diphosphate; isopropenylphenyl diphenyl phosphate; 4-phenylphenolformaldehyde phenylphosphonate; tris(2,6-xylyl) phosphate; resorcinol bis(di-2,6-xylyl phosphate); bisphenol S bis(diphenyl phosphate); resorcinol-bisphenol A phenyl phosphates.

Preferably, the aromatic phosphate ester is added as a liquid.

Preferably, the aromatic phosphate ester is bisphenol A bis(diphenyl phosphate).

### Halogenated Flame Retardant Composition

Preferably, the halogenated flame retardant composition comprises a brominated flame retardant.

Suitable examples include tetrabromobisphenol A derivatives, including bis(2-hydroxyethyl)ether of tetrabromobisphenol A, bis(3-acryloyloxy-2-hydroxypropyl)ether of tetrabromobisphenol A, bis(3-methacryloyloxy-2-hydroxypropyl)ether of tetrabromobisphenol A, bis(3-hydroxypropyl)ether of tetrabromobisphenol A, bis(2,3-dibromopropyl)ether of tetrabromobisphenol A, diallyl ether of tetrabromobisphenol A, and bis(vinylbenzyl)ether of tetrabromobisphenol A; brominated polycarbonates, tetrabromobisphenol A polycarbonate oligomer, brominated polyacrylate such as polypentabromobenzyl acrylate; brominated polystyrenes, such as polydibromostyrenes and polytribromostyrenes; brominated BPA polyepoxides, tetrabromocyclooctanes; dibromoethyldibromocyclohexanes such as 1,2-dibromo-4-(1,2-dibromoethyl)-cyclohexane; ethylene-bis-tetrabromophthalimide; hexabromocyclododecanes; tetrabromophthalic anhydrides; brominated diphenylethers such as decabromodiphenyl ether; poly(2,6-dibromophenylene ether); tris(2,4,6-tribromophenoxy-1,3,5-triazine; tris(tribromoneopentyl)phosphate; and decabromodiphenyl ethane. Particularly preferred examples include bis(2,3-dibromopropyl) ether of tetrabromobisphenol A (commercially available as FR-720 from ICL Industrial products) and polypentabromobenzyl acrylate (commercially available as FR-1025 from ICL Industrial products), tris(tribromoneopentyl)phosphate (commercially available as FR-370 from ICL Industrial products), decabromodiphenyl ether (commercially available as FR-1210 from ICL Industrial products) and decabromodiphenyl ethane (commercially available as FR-1410 from ICL Industrial products).

Most preferred is bis(2,3-dibromopropyl)ether of tetrabromobisphenol A.

### (C) Anti-Drip Agent

Preferably, the amount of the component (C) with respect to the total composition is 0.05 to 1.00 wt %, more preferably 0.10 to 0.50 wt %, more preferably 0.15 to 0.30 wt %.

Preferably, the amount of the fluoropolymer with respect to the particles is at least 55 wt %, at least 75 wt %, at least 90 wt %, at least 95 wt %, at least 97 wt %, at least 98 wt %, at least 99 wt %, at least 99.5 wt %, at least 99.9 wt % or 100 wt %.

Examples of the fluoropolymer include polytetrafluoroethylene (PTFE), polytetrafluoroethylene-perfluoroalkoxyethylene copolymer and polytetrafluoroethylene-polyhexafluoropropylene copolymer.

Commercially available products of particles of polytetrafluoroethylene include TF9201Z, TF9205, TF9207 and TF2025Z available from 3M, KT-300M, KT-400M, KT-600M, KTL-450, KTL-610, KTL-620, KTL-20N, KTL-10N, KTL-8N, KTL-4N, KTL-2N, KTL-1N, KTL-8F, KTL-500F available from Kitamura Co., Ltd. and ZONYL™ MP 1000, ZONYL MP 1100, ZONYL MP 1150, ZONYL MP 1200, ZONYL MP 1300, ZONYL MP 1400, ZONYL MP 1500 and ZONYL MP 1600 available from E.I. du Pont de Nemours & Co.

The particles have an average particle size as determined in accordance with ISO13320:2020 of 0.1 to 50 μm. Preferably, the average particle size of the particles as determined in accordance with ISO13320:2020 is at most 40 μm, at most 30 μm, at most 20 μm, at most 15 μm or at most 10 μm.

In some preferred embodiments, the average particle size of the particles as determined in accordance with ISO13320:2020 is 1.0 to 15 μm, preferably 2.0 to 10 μm. This results in a particularly high impact strength of the composition according to the invention.

Herein, the average particle size of the particles refers to the particle size measured before (C) is melt-mixed with the other components. Accordingly, the composition according to the present invention may also be described as a composition obtained by melt-mixing (A) a propylene-based polymer, (B) a flame retardant composition and (C) an anti-drip agent in the form of particles comprising a fluoropolymer and having an average particle size as determined in accordance with ISO13320:2020 of 0.1 to 50 μm.

Preferably, the total amount of components (A), (B) and (C) is at least 90 wt %, at least 95 wt %, at least 97 wt %, at least 98 wt %, at least 99 wt %, at least 99.5 wt %, at least 99.9 wt % or 100 wt % of the total composition.

### (D) Additives

The composition according to the invention may optionally comprise additives. The additives may include nucleating agents, stabilizers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; blowing agents.

The skilled person can readily select any suitable combination of additives and additive amounts without undue experimentation. The amount of the additives depends on their type and function and typically is of from 0 to about 10 wt %. The amount of the additives may e.g. be from about 0.1 to about 5 wt %; from about 1 to about 4 wt % or from 1.5 to about 3 wt % based on the total composition. The total amount of (A), (B), (C) and (D) should add up to 100% by weight.

In some preferred embodiments, the additives may include synergists. Synergists are compounds which enhance the flame retarding properties of the other flame retardants and thus enable to use the other flame retardants in substantially reduced amounts.

Synergists encompass a group of compounds known as “free radical initiators’ which include organic peroxide, dibenzyl compounds, disulfides, hydrazones, sulfenamides and azocompounds.

Typically, such synergists are used in combination with halogenated flame retardants. These synergists may be halogenated themselves.

Non-halogenated synergists include N-hydrocarbyloxy hindered amines (also known as NOR-hindered amines), non-halogenated azo, hydrazine and peroxide derivatives. The use of such non-halogenated synergists may diminish the problems relating to halogenated flame retardants.

### Process for Making Composition

The composition of the invention may be obtained by a process comprising melt-mixing (A), (B), (C) and optionally (D) by using any suitable means. Accordingly, the invention further relates to a process for the preparation of the composition according to the invention comprising melt mixing (A), (B), (C) and optionally (D). Preferably, the composition of the invention is made in a form that allows easy processing into a shaped article in a subsequent step, like in pellet or granular form. The composition can be a mixture of different particles or pellets; like a blend of the heterophasic propylene copolymer and a masterbatch of additives. Preferably, the composition of the invention is in pellet or granular form as obtained by mixing all components in an apparatus like an extruder; the advantage being a composition with homogeneous and well-defined concentrations of the additives.

With melt-mixing is meant that the components (B) and (C) and optionally (D) are mixed with (A) at a temperature that exceeds the melting point of (A). Melt-mixing may be done using techniques known to the skilled person, for example in an extruder. Generally, in the process of the invention, melt-mixing is performed at a temperature in the range from 170-300° C. Suitable conditions for melt-mixing, such as temperature, pressure, amount of shear, screw speed and screw design when an extruder is used are known to the skilled person.

### Properties of Composition

### MFI

The composition according to the invention may have a melt flow index as measured according to ISO1133-1:2011 (2.16 kg/230° C.) of 0.1 to 50 dg/min, for example 1 to 40 dg/min, 5 to 30 dg/min, 8 to 25 dg/min, 9 to 20 dg/min or 10 to 15 dg/min.

Preferably, the composition according to the invention has a flame retardancy of VO according to the UL94 test standard at a sample thickness of 2 mm, wherein the sample was conditioned at 23° C. and 50 percent relative humidity for 48 hours prior to testing.

Preferably, the composition according to the invention has a flame retardancy of VO according to the UL94 test standard at a sample thickness of 2 mm, wherein the sample was conditioned at 70° C. and 50 percent relative humidity for 168 hours prior to testing.

Preferably, the composition according to the invention has a flame retardancy of VO according to the UL94 test standard at a sample thickness of 1.6 mm, wherein the sample was conditioned at 23° C. and 50 percent relative humidity for 48 hours prior to testing.

Preferably, the composition according to the invention has a flame retardancy of VO according to the UL94 test standard at a sample thickness of 1.6 mm, wherein the sample was conditioned at 70° C. and 50 percent relative humidity for 168 hours prior to testing.

The composition according to the invention may be processed by any conventional technique known in the art into an article. Suitable examples of processing techniques wherein the composition according to the invention may be used include injection moulding, injection blow moulding, injection stretch blow moulding, injection foam moulding, rotational moulding, compression moulding, extrusion, extrusion compression moulding, extrusion blow moulding, sheet extrusion, film extrusion, cast film extrusion, foam extrusion, thermoforming and thin-walled injection moulding.

The invention further relates to an article comprising the composition according to the invention. In particular, the invention relates to an article comprising the composition according to the invention, wherein the article is made by one of the processing techniques mentioned above. Injection moulding is widely used to produce articles such as for example caps and closures, base and lids, batteries, pails, containers, external and internal parts in appliances, like printed circuit board holder, circuit breaker cover, drain pan in refrigerator, deflection coil of TV, stadium seats, automotive exterior parts like bumpers, automotive interior parts like instrument panels, or automotive parts under the bonnet. Extrusion is for example widely used to produce articles, such as rods, sheets, films and pipes. Thin wall injection moulding may for example be used to make thin wall packaging.

Preferably, the article according to the invention is caps and closures, base and lids, batteries, pails, containers, external and internal parts in appliances, like printed circuit board holder, circuit breaker cover, drain pan in refrigerator, deflection coil of TV, stadium seats, automotive exterior parts like bumpers, automotive interior parts like instrument panels, or automotive parts under the bonnet. The invention further relates to the use of the article comprising the composition according to the invention for caps and closures, base and lids, batteries, pails, containers, automotive exterior parts like bumpers, automotive interior parts like instrument panels, or automotive parts under the bonnet.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Materials

ICP1: PP 90910 is a heterophasic copolymer having MFI (ISO1133-1:2011, 230° C., 2.16 kg) of 22 dg/min consisting of a matrix of a propylene homopolymer and 35 wt % of a dispersed phase of a propylene-ethylene copolymer (ethylene content in dispersed phase: 51.5 wt %).

ICP2: PP 86MF97 is a heterophasic copolymer having MFI (ISO1133-1:2011, 230° C., 2.16 kg) of 4.6 dg/min consisting of a matrix of a propylene homopolymer and 24.5 wt % of a dispersed phase of a propylene-ethylene copolymer (ethylene content in dispersed phase: 56.5 wt %).

ICP3: PP PHC31 is a heterophasic copolymer having MFI (ISO1133-1:2011, 230° C., 2.16 kg) of 14.5 dg/min consisting of a matrix of a propylene homopolymer and 15 wt % of a dispersed phase of a propylene-ethylene copolymer (ethylene content in dispersed phase: 49 wt %).

ICP4: PP BPC40A is a heterophasic copolymer having MFI (ISO1133-1:2011, 230° C., 2.16 kg) of 40 dg/min consisting of a matrix of a propylene homopolymer and 20% of a dispersed phase of a propylene-ethylene copolymer (ethylene content in dispersed phase: 60 wt %).

FR1:10-15% ammonium polyphosphate, 60-70% melamine phosphate, 15-20% organophosphorus compound (not melamine phosphate) and 3-8% zinc oxide FR2: bis(2,3-dibromopropyl) ether of tetrabromobisphenol A
Anti-dripping agent 1: T-SAN (Teflon (PTFE)-Styrene-Acrylonitrile, mean particle size 400 μm
Anti-dripping agent 2: PTFE TF 9205 available from 3M, average particle size 8 μm (ISO13321)
Anti-dripping agent 3: PTFE TF 2025Z available from 3M, average particle size 500 nm (ISO13321)
Colorant: PLASBLAK® PE 4884, polyethylene based black masterbatch
SB₂O₃ MB: 80% of SB₂O₃ in PP masterbatch

The components as shown in Tables 1 and 2 were melt-mixed to obtain compositions as shown in Tables 1 and 2.

The properties of the compositions were measured as follows and are shown in Tables 1 and 2.
MFI (dg/min): ISO 1133-1:2011 (2.16 kg, 230° C.)
Izod impact strength (kJ/m²): ISO 180/1A (parallel) at 23° C. after 7 days
Flexural modulus (MPa): ISO 178 (parallel) at 23° C. after 7 days
Tensile modulus (MPa): ISO527/1A (parallel) at 23° C. after 7 days
Tensile strength (MPa): ISO527/1A (parallel) at 23° C. after 7 days
Density (kg/m3): ISO1183 at 23° C. after 7 days
Limiting oxygen index (LOI) (vol %): ISO4589 at 3.2 mm

The flame retardancy was measured according to the UL94 test standard at a sample thickness of 2 mm and 1.6 mm.

The samples were made under standard molding conditions for making UL bar of 2 mm thickness.

| | | |
|---|---|---|
| Melt temperature | ° C. | 220 |
| Mold temperature | ° C. | 40 |
| Injection speed | mm/s | 20-150 |

The samples were conditioned at 23° C. and 50% relative humidity for 48 hours prior to testing or at 70° C. and 50% relative humidity for 168 hours. The sample bars were burnt at the gated end for Vx evaluation.

TABLE 1

| | Ex 1 | CEx 2 | CEx 3 | CEx 4 |
|---|---|---|---|---|
| ICP1 | 80.5 | 80.5 | 80.4 | 80.3 |
| FR1 | 18 | 18 | 18 | 18 |
| antioxidant 1 | 0.1 | 0.1 | 0.1 | 0.1 |
| antioxidant 2 | 0.1 | 0.1 | 0.1 | 0.1 |
| calcium stearate | 0.1 | 0.1 | 0.1 | 0.1 |
| anti-dripping | | 0.2 | 0.3 | 0.4 |
| agent 1 | | | | |
| anti-dripping | 0.2 | | | |
| agent 2 | | | | |
| colorant | 1 | 1 | 1 | 1 |
| Testing results | | | | |
| MFI | 14.5 | 12.4 | 11.9 | 10.5 |
| Izod impact | 15.7 | 10.3 | 11.3 | 10.5 |
| strength | | | | |
| Flexural | 981 | 1019 | 1039 | 1063 |
| modulus | | | | |
| UL94 @2 mm | | | | |
| Rating @23° C. | V0 | V1 | NR | NR |
| after 48 hours, | | | | |
| Flame dripping | No | No | Yes | Yes |
| Rating @70° C. | V0 | V1 | NR | NR |
| after 168 hours | | | | |
| Flame dripping | No | No | Yes | Yes |

The composition of Ex 1 according to the invention comprising anti-dripping agent 2 shows a better flame retardancy than the compositions of CEx 2-4 comprising anti-dripping agent 1. Notably, Ex 1 shows a better flame retardancy than CEx 4 which contains a comparable amount of PTFE (50% of 0.4 wt %) as Ex 1 (0.2 wt %).

TABLE 2

| | CEx 5 | Ex 6 | Ex 7 | CEx 8 |
|---|---|---|---|---|
| ICP2 | 41.4 | 41.3 | 41.3 | 41.2 |
| ICP3 | 41.5 | 41.4 | 41.4 | 41.3 |
| ICP4 | 0.4 | 0.4 | 0.4 | 0.4 |
| FR2 | 12.5 | 12.5 | 12.5 | 12.5 |
| antioxidant 3 | 0.2 | 0.2 | 0.2 | 0.2 |
| anti-dripping | | | | 0.4 |
| agent 1 | | | | |
| anti-dripping | | 0.2 | | |
| agent 2 | | | | |
| anti-dripping | | | 0.2 | |
| agent 3 | | | | |
| 80% | 4 | 4 | 4 | 4 |
| SB203:PP | | | | |
| MB | | | | |
| Testing | | | | |
| results | | | | |
| MFI | 7.94 | 11 | 10.6 | 8.81 |
| Izod impact | No data | 11.61 | 9.56 | 9.93 |
| strength | | | | |
| Tensile | No data | 1044.4 | 1082.2 | 1091.8 |
| modulus | | | | |
| Tensile | No data | 22.1 | 22.8 | 22.7 |
| strength | | | | |
| Density | No data | 991.1 | 985.4 | 978.8 |
| LoI | No data | 27.1 | 25.1 | 23.9 |
| UL94 | No data | V0 | V0 | V2 |
| @1.6 mm | | | | |
| @23° C. after | | | | |
| 48 hours | | | | |

The compositions of Ex 6 and 7 according to the invention comprising anti-dripping agent 2 and 3 show a better flame retardancy than the compositions of CEx 5 without an anti-dripping agent and CEx 8 comprising anti-dripping agent 1.

Notably, the composition of Ex 6 comprising anti-dripping agent 2 having average particle size 8 μm has a higher impact strength than the composition of Ex 7 comprising anti-dripping agent 3 having average particle size 0.5 μm.

1. A composition comprising (A) a propylene-based polymer, (B) a flame retardant composition and (C) an anti-drip agent in the form of particles comprising a fluoropolymer and having an average particle size as determined in accordance with ISO13320:2020 of 0.1 to 50 μm.

2. The composition according to claim 1, wherein the amount of the fluoropolymer with respect to the particles of (C) is at least 55 wt %.

3. The composition according to claim 1, wherein the fluoropolymer is selected from the group consisting of polytetrafluoroethylene, polytetrafluoroethylene-perfluoroalkoxyethylene copolymer and polytetrafluoroethylene-polyhexafluoropropylene copolymer.

4. The composition according to claim 1, wherein the average particle size of the particles as determined in accordance with ISO13320:2020 is 1.0 to 15 μm.

5. The composition according to claim 1, wherein the amount of (A) with respect to the composition is 55 to 95 wt %, the amount of (B) with respect to the composition is 1.0 to 40 wt % and the amount of (C) with respect to the composition is 0.05 to 1.00 wt %.

6. The composition according to claim 1, wherein component (A) comprises a heterophasic propylene copolymer consisting of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %.

7. The composition according to claim 1, wherein (B) is a halogen-free flame retardant composition.

8. The composition according to claim 7, wherein the halogen-free flame retardant composition comprises an organophosphorus compound.

9. The composition according to claim 1, wherein (B) is a halogenated flame retardant composition.

10. The composition according to claim 9, wherein the halogenated flame retardant composition comprises a brominated flame retardant.

11. The composition according to claim 1, wherein the composition has a melt flow index as measured according to ISO1133-1:2011 (2.16 kg/230° C.) of 0.1 to 50 dg/min.

12. The composition according to claim 1, wherein the composition has at least one of:
a flame retardancy of VO according to the UL94 test standard at a sample thickness of 2 mm, wherein the sample was conditioned at 23° C. and 50 percent relative humidity for 48 hours prior to testing;
a flame retardancy of VO according to the UL94 test standard at a sample thickness of 2 mm, wherein the sample was conditioned at 70° C. and 50 percent relative humidity for 168 hours prior to testing;
a flame retardancy of VO according to the UL94 test standard at a sample thickness of 1.6 mm, wherein the sample was conditioned at 23° C. and 50 percent relative humidity for 48 hours prior to testing, or
a flame retardancy of VO according to the UL94 test standard at a sample thickness of 1.6 mm, wherein the sample was conditioned at 70° C. and 50 percent relative humidity for 168 hours prior to testing.

13. A process for the preparation of a composition, the process comprising melt mixing (A) a propylene-based polymer, (B) a flame retardant composition and (C) an anti-drip agent in the form of particles comprising a fluoropolymer and having an average particle size as determined in accordance with ISO13320:2020 of 0.1 to 50 μm.

14. An article obtained by injection molding the composition according to claim 1.

15. The article according to claim 14 which is selected from the group consisting of caps and closures, base and lids, batteries, pails, containers, external and internal parts in appliances, like printed circuit board holder, circuit breaker cover, drain pan in refrigerator, deflection coil of TV, stadium seats, automotive exterior parts, and automotive interior parts.

16. An article comprising the composition of claim 1.
